(19) United States
(12) Patent Application Publication
(10) Pub. No.: US 2017/0288428 A1
(43) Pub. Date: Oct. 5, 2017

(54) BATTERY CHARGER AND METHOD OF DETECTING ABNORMALITY OF BATTERY CHARGER

(71) Applicant: MAKITA CORPORATION, Anjo-shi (JP)

(72) Inventor: Yoshihiro ISHIKAWA, Anjo-shi (JP)

(73) Assignee: MAKITA CORPORATION, Anjo-shi (JP)

(21) Appl. No.: 15/451,832

(22) Filed: Mar. 7, 2017

(30) Foreign Application Priority Data
Mar. 31, 2016 (JP) 2016-072236

(51) Int. Cl. H02J 7/00

(52) U.S. Cl. CPC H02J 7/0026

(57) ABSTRACT

A battery charger in one aspect of the present disclosure comprises a charging unit, a first voltage detector, a second voltage detector, and a determination unit. The determination unit determines that there is an abnormality in at least one of a charge path or a detection path when an absolute value of a difference between a voltage of a battery detected by the first voltage detector and a voltage of the battery detected by a second voltage detector is equal to or greater than a threshold value.

### CROSS-REFERENCE TO RELATED APPLICATIONS

This application claims the benefit of Japanese Patent Application No. 2016-072236 filed on Mar. 31, 2016 with the Japan Patent Office, the disclosure of which is incorporated herein by reference.

### BACKGROUND

The present disclosure relates to a battery charger that charges a battery.

A battery charger is usually provided with a voltage detector that detects a battery voltage. When a battery is being charged, a charging current or charging voltage to the battery is controlled based on detection results by the voltage detector.

In addition, Japanese Unexamined Patent Application Publication No. H07-184325 discloses that detection results by a voltage detector are used in detecting an abnormality such as disconnection or short-circuit in a battery or a battery charger, or, disconnection or contact failure at the connection point between the battery and the battery charger.

### SUMMARY

When detecting a value of the battery voltage via a charge path through which the charging current to the battery flows, the detected value of the battery voltage is occasionally lower than a true value of the battery voltage. This happens because of a voltage drop that occurs due to a current flow in the charge path. And, when the detected value of the battery voltage is lower than the true value, there is a risk of incidents such as an overcharge, for example. In other words, there is a possibility that battery charging cannot be performed in a normal manner.

To prevent such problems, a detection path that is not used for the charging current to flow may be provided besides the charge path, and the battery voltage may be detected via this detection path.

However, this may lead to a possibility, for example, that an abnormality such as disconnection or short-circuit in the charge path cannot be detected from the detected battery voltage. Moreover, when an abnormality such as disconnection or short-circuit occur in the detection path, there is a possibility, for example, that the battery voltage is recognized as “0” (zero) by the voltage detector despite the battery being fully charged and that the battery is thus overcharged.

It is desirable that one aspect of the present disclosure can detect abnormalities, such as those described above, in the battery charger.

The battery charger in one aspect of the present disclosure comprises a positive-electrode terminal, a negative-electrode terminal, a charging unit, a first voltage detector, a second voltage detector, and a determination unit. The positive-electrode terminal and the negative-electrode terminal are respectively coupled to a positive electrode and a negative electrode of a battery. The charging unit charges the battery via a charge path that is coupled to the positive-electrode terminal and the negative-electrode terminal. The first voltage detector detects a voltage of the battery via a detection path, which is a different path from the charge path. The second voltage detector detects the voltage of the battery via the charge path. The determination unit determines that there is an abnormality in at least one of the charge path or the detection path when an absolute value of a difference between the voltage detected by the first voltage detector and the voltage detected by the second voltage detector is equal to or greater than a threshold value.

That is to say that, the difference between the voltage detected by the first voltage detector and the voltage detected by the second voltage detector is assumed to be small when both of the charge path and the detection path are normal. In contrast, the aforementioned difference is assumed to be large when there is an abnormality, such as disconnection or contact failure, in one of the charge path or the detection path.

Accordingly, it is possible to detect whether there is an abnormality in one of the charge path or the detection path by determining whether the absolute value of the aforementioned difference is equal to or greater than the threshold value.

The determination unit may further be configured to disable battery charging by the charging unit when it determines that there is the abnormality in at least one of the charge path or the detection path.

Abnormal charging to the battery, such as an overcharge of the battery, can be reduced by such a configuration.

The determination unit may further be configured to set the threshold value to a first threshold value before battery charging by the charging unit is initiated, and determine whether there is the abnormality based on the absolute value and the first threshold value.

According to this configuration, it is possible to detect an occurrence of an abnormality in either one of the charge path or the detection path before battery charging by the charging unit is initiated.

Moreover, the determination unit may further be configured to detect the abnormality in the charge path or in the detection path based on the absolute value and the threshold value after battery charging by the charging unit is initiated.

In this case, since a charging current is flowing through the charge path, the voltage detected by the second voltage detector is affected by a voltage drop that occurs in the charge path. Thus, the aforementioned difference is likely to increase, although the charge path and the detection path are normal. Consequently, there is a risk that the precision of detecting abnormalities in the charge path or in the detection path may decrease.

For this reason, the determination unit may further be configured to set the threshold value to a second threshold value that is greater than the first threshold value when battery charging by the charging unit is initiated, and determine whether there is the abnormality based on the second threshold value.

This can reduce a decrease in the precision of detecting abnormalities in the charge path or in the detection path.

Moreover, the determination unit may further be configured to increase the second threshold value as the charging current that flows through the charge path increases.

This can further reduce a decrease in the precision of detecting abnormalities in the charge path or in the detection path.

Moreover, the battery charger may be configured to selectively go into one charging mode among two or more charging modes and operate in the one charging mode. In this case, the determination unit may further be configured to set the threshold value to one threshold value that is appropriate for the one charging mode and determine whether there is the abnormality based on the one threshold value.

The battery charger configured as such can reduce a decrease in the precision, which is induced by variations in the charging modes, of detecting abnormalities in the charge path or in the detection path.

The detection path may be coupled to at least one of the positive-electrode terminal or the negative-electrode terminal

The detection path may also be coupled to a detection terminal that is disposed to the battery charger for a connection to at least one of the positive electrode or the negative electrode of the battery.

The aforementioned battery charger may further comprise a control unit that is configured to control battery charging by the charging unit. The battery charger configured as such can control battery charging by the charging unit.

The battery may be configured to be used for worksite power equipment. The worksite power equipment may refer to electric machinery used at worksite of home carpentry, manufacturing, gardening, and construction. Specifically, the worksite power equipment may be, for example, power tools for stone processing, metal processing, and wood processing; or machinery for gardening; or electric machinery for arranging worksite environment. More specifically, the worksite power equipment may be, for example, electric hammers, electric hammer drills, electric drills, electric screwdrivers, impact wrenches, electric grinders, electric circular saws, electric reciprocating saws, jigsaws, electric cutters, electric chain saws, electric planers, electric nail guns (including riveting machines), electric hedge trimmers, electric lawn mowers, electric grass trimmers, electric bush cutters, electric cleaners, electric blowers, electric sprayers, electric spreaders, electric dust collectors, worksite lightings, or worksite audio equipment such as radios and speakers.

The battery may be housed in a battery pack.

Another aspect of the present disclosure is a method of detecting an abnormality of a battery charger for charging a battery, wherein the battery charger comprises a charge path and a detection path, which is a different path from the charge path.

The method comprises detecting a voltage of the battery via the detection path; detecting a voltage of the battery via the charge path; and, determining that there is the abnormality in at least one of the charge path or the detection path when an absolute value of a difference between the voltage detected via the detection path and the voltage detected via the charge path is equal to or greater than a threshold value.

Such a method can exhibit the same effects as the effects of the aforementioned battery charger.

Yet another aspect of the present disclosure is a method of detecting an abnormality of a battery charger for charging a battery.

The method comprises providing a charge path to the battery in the battery charger; providing a detection path that detects a voltage of the battery in addition to the charge path; detecting a voltage of the battery via the detection path; detecting a voltage of the battery via the charge path; and, determining that there is the abnormality in at least one of the charge path or the detection path when an absolute value of a difference between the voltage detected via the detection path and the voltage detected via the charge path is equal to or greater than a threshold value.

Such a method can exhibit the same effect as those of the aforementioned battery charger.

### BRIEF DESCRIPTION OF THE DRAWINGS

An exemplary embodiments of the present disclosure will be explained hereinafter as an example with reference to the accompanying drawings, in which:

FIG. 1 is a circuit diagram of a battery and a battery charger in an embodiment;

FIG. 2 is an explanatory diagram that shows state transition of the battery charger;

FIG. 3 is a flowchart of abnormality determination process that is performed in a control circuit;

FIG. 4 is an explanatory diagram that shows a table for setting a threshold value Vth for abnormality determination; and,

FIG. 5 is a circuit diagram of a battery charger in a modified example.

### DETAILED DESCRIPTION OF THE PREFERRED EMBODIMENTS

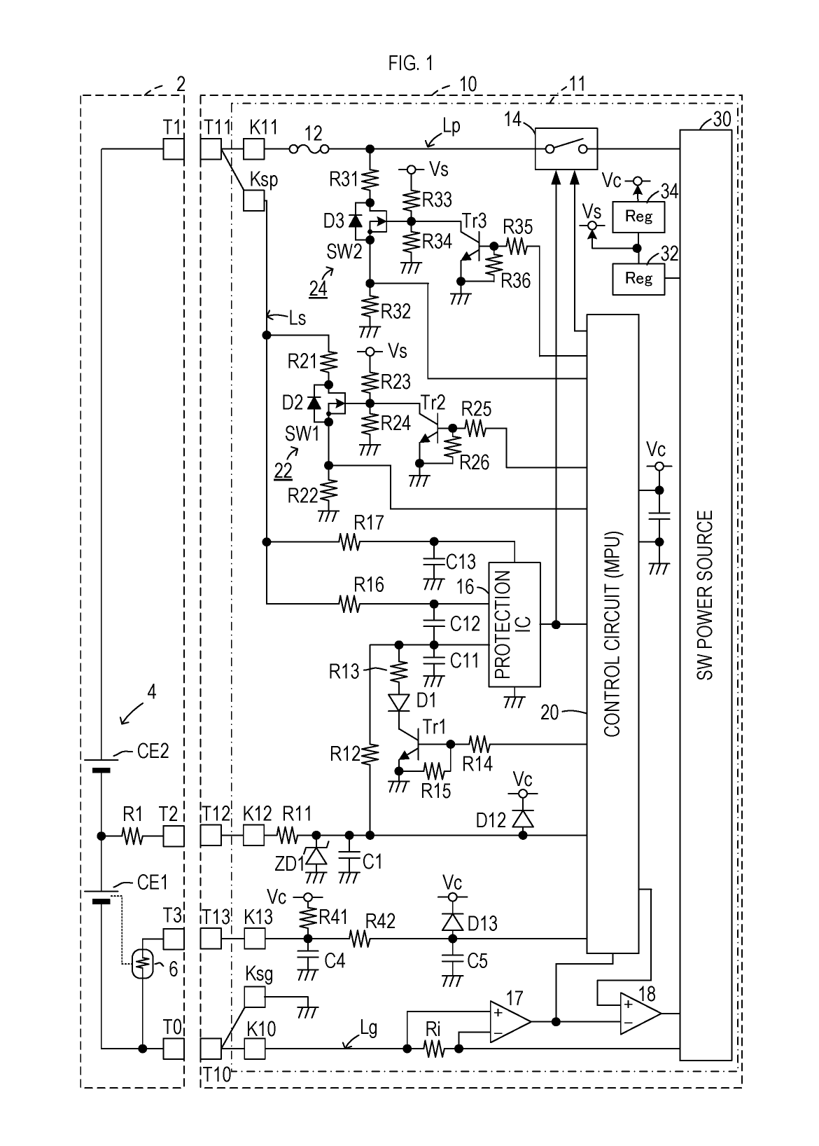

As shown in FIG. 1, a battery charger 10 in this exemplary embodiment is configured to charge a battery 4. The battery 4 comprises one or more chargeable cells. As one example, the battery 4 comprises two serially coupled cells, CE1 and CE2, in the present embodiment.

The battery 4 is a lithium ion battery, for example. The battery 4 is housed in a synthetic resin package in the battery pack 2 along with a temperature sensor (a thermistor, for example) 6, which is for detecting a temperature of the battery 4 (cell CE1, for example), (hereinafter, referred to as “battery temperature”). The battery pack 2 comprises four terminals, T0 to T3, which are coupled to the battery charger 10 or to worksite power equipment (power tools, for example).

The terminal T0 is coupled to a negative electrode (−) of the battery 4; and the terminal T1 is coupled to a positive electrode (+) of the battery 4. The terminal T2 is coupled to a connection point of the cell CE1 and the cell CE2 via a resistor R1. The terminal T3 is coupled to a first end of the temperature sensor 6.

A second end of the temperature sensor 6 is coupled to the negative electrode of the battery 4 and the terminal T0.

In the battery pack 2 configured as described above, a voltage of the battery 4 (hereinafter, referred to as “battery voltage”) is outputted from the terminals T0, and T1. The terminal T2 outputs a voltage of a connection point of the cell CE1 and the cell CE2 (that is, a voltage of the positive electrode of the cell CE1). The terminal T3 outputs a temperature-detection signal that indicates a detected battery temperature (a temperature of the cell CE1, for example).

Meanwhile, an attaching part, which is not shown, and to which the battery pack 2 is attached, is disposed to the battery charger 10 (more specifically, a case of the battery charger 10). The battery charger 10 comprises terminals T10 to T13, which are respectively coupled to the aforementioned terminals T0 to T3 when the battery pack 2 is attached to the attaching part.

The terminals T10 to T13 are respectively coupled to terminals K10 to K13 of a circuit board 11 that is housed in the battery charger 10.

The terminal T10 (in other words, the negative-electrode terminal) is coupled to the negative electrode of the battery 4 via the terminal T0 of the battery pack 2; and, the terminal T11 (in other words, the positive-electrode terminal) is coupled to the positive electrode of the battery 4 via the terminal T1 of the battery pack 2. The terminals K10, and K11 are respectively coupled to a charge path Lg that is disposed on the negative electrode side of the circuit board 11, and a charge path Lp that is disposed on the positive electrode side of the circuit board 11. The terminals T10, and T11 are respectively coupled to terminals Ksg, and Ksp, which are different from the terminals K10, and K11.

The terminal Ksg is coupled to a ground line of the circuit board 11. Meanwhile, the terminal Ksp is coupled to a detection path Ls that is disposed inside the battery charger 10. The detection path Ls is disposed between the terminal Ksp and the ground line of the circuit board 11 such that the detection path Ls can detect the battery voltage without being influenced by a charging current to the battery 4.

The circuit board 11 is equipped with a switching power source (hereinafter referred to as SW power source) 30, which is one example of the charging unit, and a control circuit 20, which is one example of the determination unit and the control unit.

The charging current flows from the SW power source 30 towards the terminals K11 and T11 through the charge path Lp that is disposed on the circuit board 11. The charging current also flows from the terminals T10 and K10 towards the SW power source 30 through the charge path Lg.

The charge path Lp comprises a fuse 12, and a charging switch 14. The fuse 12 interrupts the charge path Lp when an overcurrent flows through the charge path Lp. The charging switch 14 completes or interrupts the charge path Lp in accordance with outputs from the control circuit 20 or from a protection IC 16, which will be mentioned later.

The charge path Lg comprises a resistor R1 for detecting a current (charging current) that flows through this charge path Lg. Both ends of the resistor R1 are coupled to a current-detecting-circuit 17 for detecting a voltage between the both ends. An output from the current-detecting-circuit 17 is inputted to the control circuit 20.

The SW power source 30 is supplied with electric power from an external alternating-current power source (commercial power source, for example), and generates a charging voltage (direct-current voltage) for charging the battery 4.

The circuit board 11 comprises regulators 32 and 34. The regulators 32 and 34 use the direct-current voltage generated in the SW power source 30 and respectively generate drive voltages (direct-current constant voltages), Vs and Vc, for driving an internal circuit.

More specifically, the drive voltage Vc is 5V, for example, and is lower than the drive voltage Vs (10V, for example). The regulator 34 uses the drive voltage Vs generated in the regulator 32 to generate the drive voltage Vc.

In the present embodiment, the control circuit 20 comprises a microprocessor unit (MPU) that includes a memory and input/output circuits. The control circuit 20 detects, for example, a battery voltage, a cell voltage, and a battery temperature when the battery pack 2 is attached to the battery charger 10, and controls charging to the battery 4. In other embodiments, a part of or all of the function of the MPU may be achieved by combinations of individual electronic components of various kinds; or, by an Application Specified Integrated Circuit (ASIC); or, by an Application Specific Standard Product (ASSP); or, by programmable logic devices such as a Field Programmable Gate Array (FPGA); or, by any combinations of them.

The control circuit 20 is operated by the drive voltage Vc that is generated in the regulator 34. The control circuit 20 then detects the battery voltage from the charge path Lp via a voltage-detecting circuit 24. The control circuit 20 also detects the battery voltage from the detection path Ls via the voltage-detecting circuit 22.

In addition, the control circuit 20 obtains a voltage of the connection point of the cell CE1 and the cell CE2 (that is, a voltage of the positive electrode of the cell CE2) from the terminal K12, which is coupled to the terminal T12, via the resistor R11.

The control circuit 20 determines that there is an abnormality in either one of the charge path Lp or the detection path Ls when the absolute value of the difference between the battery voltage detected by the voltage-detecting circuit 22 and the battery voltage detected by the voltage-detecting circuit 24 is equal to or greater than a threshold value Vth. The control circuit 20 disables charging to the battery 4 when this determination is made.

As it is described above, the detection path Ls, which is different from the charge path Lp, is a path for detecting a battery voltage and leads to the ground line (thus to the terminal Ksg) from the terminal T11 via the terminal Ksp.

The control circuit 20 uses the battery voltage detected from the detection path Ls by the voltage-detecting circuit 22 for controlling charging to the battery 4 when it determines that both of the charge path Lp and the detection path Ls are normal.

This is because, while the battery voltage detected by the voltage-detecting circuit 24 is influenced by a voltage drop that occurs due to a flow of the charging current through the charge path Lp (more specifically, through the path from the fuse 12 to the terminal T11 via the terminal K11), the battery voltage detected by the voltage-detecting circuit 22 does not receive such influence and thus is detected with high accuracy.

The control circuit 20 also detects a cell voltage of each of the cells CE1 and CE2, which are included in the battery 4, based on the voltage of the positive electrode of the cell CE2 (that is, the cell voltage of the cell CE2) obtained from the terminal K12 via the resistor R11, and the battery voltage. The control circuit 20 then determines from the result of this detection whether there is an abnormality in the battery 4. The control circuit 20 disables charging to the battery 4 if there is an abnormality.

Note that an input path of the cell voltage from the resistor R11 to the control circuit 20 is coupled to a cathode of a Zener diode ZD1, and the ground line is coupled to an anode of the Zener diode ZD1. This input path is also coupled to an anode of a diode D12. A cathode of the diode D12 is applied with the drive voltage Vc.

Moreover, this input path is coupled to a first end of a capacitor C1; and a second end of the capacitor C1 is coupled to the ground line. This is for eliminating unnecessary signal components such as noises in this input path by controlling an input voltage to the control circuit 20 within an operating voltage range of the control circuit 20.

The terminal K13 is applied with the drive voltage Vc via a resistor R41 so as to supply current to the temperature sensor 6 to obtain the temperature-detection signal. In addition, the connection point of the terminal K13 and the resistor R41 is coupled to the ground line via a capacitor C4 so as to eliminate unnecessary signal components such as noises from the temperature-detection signal.

The control circuit 20 obtains the temperature-detection signal from the terminal K13 via a resistor R42 and determines whether the battery temperature acquired from the obtained temperature-detection signal is within a predetermined allowable range. If the battery temperature is not within the allowable range, then the control circuit 20 disables charging to the battery 4.

Note that an input path of the temperature-detection signal from the resistor 42 to the control circuit 20 is coupled to an anode of a diode D13, and a cathode of the diode D13 is applied with the drive voltage Vc. This input path is also coupled to a first end of a capacitor C5; and, a second end of the capacitor C5 is coupled to the ground line. This is for controlling the input voltage to the control circuit 20 within the operating voltage range of the control circuit 20 and eliminating the unnecessary signal components such as noises.

The circuit board 11 comprises the protection IC 16 aside from the control circuit 20. The protection IC 16 monitors the battery voltage and cell voltage, and forcibly interrupts (turns off) the charging switch 14 if an abnormality occurs in the voltage under monitoring due to an overcharge or a cell failure.

The protection IC 16 is coupled to a cell voltage input path that is branched from the input path of the cell voltage, which leads to the control circuit 20 from the resistor R11, via the resistor R12. The protection IC 16 is also coupled to a battery voltage input path for obtaining the battery voltage from the terminal Ksp via the resistor R16.

A capacitor C11 is disposed between the ground line and the cell voltage input path; and a capacitor C12 is disposed between the ground line and the battery voltage input path. The capacitors C11 and C12 perform filtering of the cell voltage of the cell CE1 and the cell voltage of the cell CE2 respectively. In other words, the cell voltages of the cells CE1 and CE2 is inputted to the cell voltage protection IC 16 via the capacitors C11 and C12.

The protection IC 16 is coupled to a capacitor C13 in parallel. A first end of the capacitor C13 is coupled to the detection path Ls via a resistor R17; a second end of the capacitor C13 is coupled to the ground line. That is to say that the protection IC 16 receives a voltage between the first end and second end of the capacitor C13 (in other words, the battery voltage), and operates independently from the control circuit 20.

Thus, the battery 4 can be protected by the operation of the protection IC 16 when, for example, protection function does not work due to failures of the control circuit 20 during charging to the battery 4 and thereby the battery 4 is overcharged.

The cell voltage input path that leads to the protection IC 16 from the resistors R11 and R12 is coupled to a collector of an emitter-grounded transistor Tr1 via a resistor R13 and a diode D1.

An anode of the diode D1 is coupled to the resistor R13; and, a cathode of the diode D1 is coupled to the collector of the transistor Tr1. This enables a current to flow from the cell voltage input path towards the ground line in the forward direction of the diode D1.

The transistor Tr1 is an NPN transistor in the present embodiment. A base of the transistor Tr1 is coupled to the control circuit 20 via a resistor R14, and at the same time, coupled to the ground line via a resistor R15.

Accordingly, the transistor Tr1 is turned into an on-state by an input of a high-level drive signal from the control circuit 20. And, when the transistor Tr1 is in the on-state, the cell voltage input path that leads to the control circuit 20 from the resistor R11 is coupled to the ground line via the resistors R12 and R13, and the diode D1.

When the transistor Tr1 is in an off-state, the control circuit 20 switches the transistor Tr1 to the on-state if the cell voltage that is being detected is equal to or greater than a given voltage, which is capable of undergoing disconnection check of the cell voltage input path. The control circuit 20 performs the disconnection check of the cell voltage input path on the cell voltage that can be acquired when the transistor Tr1 is in the on-state.

In other words, if the cell voltage input path is disconnected when the transistor Tr1 is turned into the on-state, then the cell voltage that is inputted to the control circuit 20 is the ground potential (0V). On the contrary, if the cell voltage input path is normal at this point, the cell voltage is equal to or greater than the given voltage.

The control circuit 20 determines whether the cell voltage input path is disconnected by temporarily turning the transistor Tr1 into the on-state before conducting (turning on) the charging switch 14 and initiating charging to the battery 4. The control circuit 20 disables charging to the battery 4 also when it detects disconnection of the cell voltage input path.

In the present embodiment, the voltage-detecting circuit 22 is one example of the first voltage detector; and the voltage-detecting circuit 24 is one example of the second voltage detector.

The voltage-detecting circuit 22 comprises resistors R21 and R22 for dividing the battery voltage that are disposed between the detection path Ls and the ground line. The voltage divided by the resistors R21 and R22 is inputted into the control circuit 20 as a battery voltage detected by the voltage-detecting circuit 22.

The voltage-detecting circuit 24 comprises resistors R31 and R32 for dividing the battery voltage that are disposed between the charge path Lp and the ground line. The voltage that is divided by the resistors R31 and R32 is inputted into the control circuit 20 as the battery voltage detected by the voltage-detecting circuit 24.

The voltage-detecting circuit 22 comprises a detecting switch SW1 disposed between the resistor R21 and the resistor R22. The voltage-detecting circuit 24 comprises a detecting switch SW2 disposed between the resistor 31 and the resistor R32. The control circuit 20 turns the detecting switches SW1 and SW2 into the on-state when detecting the battery voltages.

This is for preventing or reducing constant flow of currents from the battery 4 to the resistors R21, R22, R31, and R32 causing wasteful consumption of electric power of the battery 4.

The detecting switches SW1 and SW2 are an n-channel MOSFETs in the present embodiment. A source of the detecting switch SW1 and a source of the detecting switch SW2 are respectively coupled to the resistors R22 and R32. A drain of the detecting switch SW1 and a drain of the detecting switch SW2 are respectively coupled to the resistors R21 and R31.

A gate of the detecting switch SW1 is applied with a divided voltage of the drive voltage Vs that is divided by resistors R23 and 24. A gate of the detecting switch SW2 is applied with a divided voltage of the drive voltage Vs that is divided by resistors R33 and 34.

Moreover, the gate of the detecting switch SW1 and the gate of the detecting switch SW2 are respectively coupled to a collector of a transistor Tr2 and a collector of a transistor Tr3. The transistors Tr2 and Tr3 are NPN transistors in the present embodiment. And, emitters of the transistors Tr2 and Tr3 are coupled to the ground line. Bases of the transistors Tr2 and Tr3 are coupled to the control circuit 20 respectively via resistors R25 and R35. A resistor R26 is disposed between the base and the emitter of the transistor Tr2; and, a resistor R36 is disposed between the base and emitter of the transistor Tr3.

The control circuit 20 normally turns the transistors Tr2 and Tr3 into the on-state and keeps the detecting switches SW1 and SW2 to an off-state. More specifically, the control circuit 20 turns the transistors Tr2 and Tr3 into the on-state by inputting a high-level signal into the base of the transistor Tr2 via the resistor R25 and into the base of the transistor Tr3 via the resistor R35.

In addition, the control circuit 20 turns the transistors Tr2 and Tr3 into the off-state when detecting the battery voltage. The gates of the detecting switches SW1 and SW2 are thereby each applied with the drive voltage, and the detecting switches SW1 and SW2 are turned into the on-state.

Note that, in FIG. 1, the diode D2 between the drain and the source of the detecting switch SW1, and the diode D3 between the drain and the source of the detecting switch SW2 represent parasitic diodes.

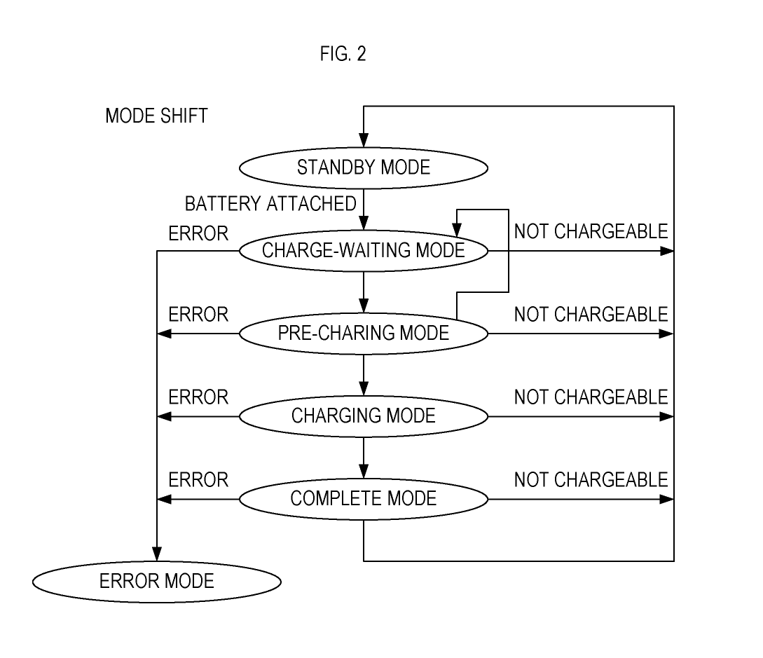

In the battery charger 10 in the present embodiment configured as described above, the control circuit 20 goes into a standby mode when the battery pack 2 is not attached to the battery charger 10 and thus the battery 4 cannot be charged (not chargeable) as shown in FIG. 2.

In the standby mode, the terminal T13 is coupled to the terminal T3 of the battery pack 2 when the battery pack 2 is attached to the battery charger 10. The voltage of the input path of the temperature-detection signal to the control circuit 20 thereby decreases to below a maximum voltage that corresponds to a power source voltage Vc. The control circuit 20 accordingly detects from this voltage change that the battery pack 2 is attached, and goes into a charge-waiting mode.

The charge-waiting mode is a mode to wait for conditions for initiating charging to be satisfied. The conditions for initiating charging are, for example, that the aforementioned charge path Lp, detection path Ls, and the cell voltage input path are normal, and that the battery temperature is within the allowable temperature range that enables charging to the battery 4.

The control circuit 20 then goes into a pre-charging mode to pre-charge the battery 4 when it is confirmed that the conditions for initiating charging are satisfied in this charge-waiting mode.

In the pre-charging mode, the control circuit 20 performs pre-charging that charges the battery 4 until the battery voltage reaches a given voltage that is lower than a voltage of a fully-charged battery 4. The control circuit 20 goes into the charging mode to fully charge the battery 4 when the pre-charging is completed. Note that, in the pre-charging mode, the control circuit 20 goes into the charge-waiting mode when the battery temperature is not within the allowable temperature range, determining that the battery is not chargeable.

After going into the charging mode, the control circuit 20 outputs a current-command value for charging the battery 4 at constant current (CC) until the battery voltage reaches a predefined voltage. When the battery voltage is equal to or greater than the predefined voltage, the control circuit 20 then performs pseudo-constant-voltage (CV) charging by gradually decreasing (in other words, decreasing in stepwise) the current-command value so that the battery voltage is constant.

For this reason, the circuit board 11 is provided with an output circuit 18 that outputs a control signal to the SW power source 30. The control signal is for controlling the charging current detected by the current-detecting-circuit 17 to the current-command value from the control circuit 20. The output circuit 18 and the current-detecting-circuit 17 comprise differential amplifiers including an operational amplifier, for example.

When the battery 4 is fully charged in the charging mode, the control circuit 20 goes into a complete mode and notifies that the battery 4 is fully charged. As the battery pack 2 is detached from the battery charger 10, the control circuit 20 then goes into the standby mode.

In the pre-charging mode and the charging mode, the control circuit 20 monitors the state of the charge path Lp and the detection path Ls as well as the battery voltage and the cell voltage. The control circuit 20 goes into an error mode when an abnormality occurs, stops charging by turning the charging switch 14 into the off-state, and notifies that the abnormality has occurred. The control circuit 20 may only notify, for example, that the abnormality has occurred when it goes into the error mode.

Such notification of completion of charging or occurrence of an abnormality may be delivered, for example, through lighting or flashing of a light emitting diode. Operation modes of the battery charger 10 may also be notified, for example, through lighting or flashing of a light emitting diode.

Next is an explanation of an abnormality determination process that is executed in the control circuit 20 for monitoring whether the charge path Lp and the detection path Ls are normal in the charge-waiting mode, the pre-charging mode, and charging mode.

This abnormality determination process is executed repeatedly at a given interval in each of the aforementioned modes.

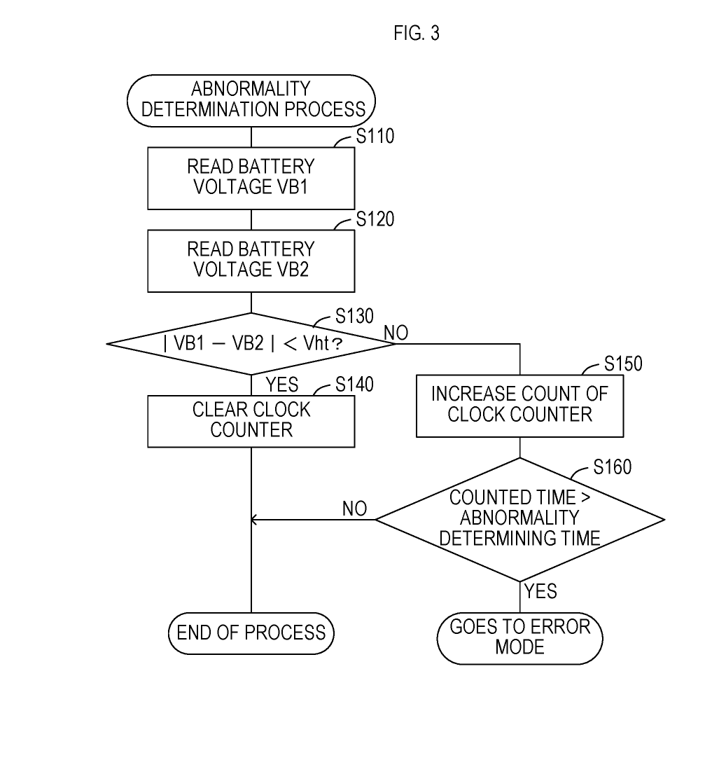

As shown in FIG. 3, the control circuit 20 reads a battery voltage VB1 from the voltage-detecting circuit 22 in S110 (S stands for step) by temporarily turning the detecting switch SW1 of the voltage-detecting circuit 22 into the on-state.

In the subsequent S120, the control circuit 20 reads a battery voltage VB2 from the voltage-detecting circuit 24 by temporarily turning the detecting switch SW2 of the voltage-detecting circuit 24 into the on-state.

During charging to the battery 4, the detecting switches SW1, and SW2 are kept to the on-state to respectively monitor the battery voltages VB1, and VB2. The control circuit 20 can thereby read each of the battery voltages VB1, and VB2 during charging to the battery 4 in S110, and S120 without turning the detecting switches SW1, and SW2 into the on-state.

In the subsequent S130, the control circuit 20 determines whether the absolute value of the difference between the battery voltage VB1 and the battery voltage VB2 (|VB1-VB2|), which are read in S110 and S120, is smaller than the threshold value Vth for determining an abnormality.

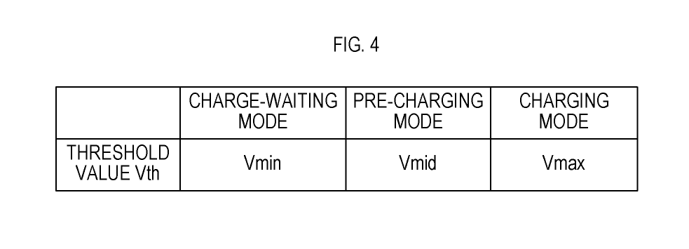

The threshold value Vth is set to a different value for each operation mode of the control circuit 20 based on the table (map) shown in FIG. 4. In the charge-waiting mode where charging to the battery 4 is not executed, the threshold value Vth is set to a minimum value Vmin (in other words, to the first threshold value).

In the pre-charging mode, in which the charging current to the battery 4 is smaller than that in the charging mode, an intermediate value Vmid (in other words, the second threshold value) that is greater than the threshold value Vmin in the charge-waiting mode and is smaller than the threshold value Vmax in the charging mode is used as the threshold value Vth.

In the charging mode, in which the charging current is the greatest, the greatest value Vmax (in other words, the second threshold value) is used as the threshold value Vth.

This is for the reason that the battery voltage VB2 detected in the voltage-detecting circuit 24 is influenced by a voltage drop that occurs due to a flow of the charging current through the charge path Lp, and that the voltage drop is increased as the charging current is increased.

In other words, when the charge path Lp and the detection path Ls are normal, the difference between the battery voltage VB1 and the battery voltage VB2 is the smallest in the charge-waiting mode, and is increased as the charging current is increased.

Accordingly, in the present embodiment, the threshold value Vth is set to a different value for each mode. It is thereby more precisely determined in each mode whether the charge path Lp and the detection path Ls are normal, or whether there is an abnormality in these paths in the present embodiment.

In the subsequent S130, if it is determined that the absolute value of the difference between the battery voltage VB1 and the battery voltage VB2 is smaller than the threshold value Vth, then the control circuit 20 determines that the charge path Lp and the detection path Ls are both normal, and the process proceeds to S140. In S140, the control circuit 20 clears a clock counter (count value: 0) that is used to determine an abnormality in the subsequent process, and ends the abnormality determination process.

Meanwhile, if it is determined in S130 that the absolute value is equal to or greater than the threshold value Vth, then the control circuit 20 increases the count of the clock counter (+1) in S150.

In the subsequent S160, the control circuit 20 determines whether a counted time, which is obtained from the count value of the clock counter that is increased in S150, exceeds a preset abnormality determining time. If the counted time does not exceed the abnormality determining time, then the control circuit 20 ends the abnormality determination process.

Moreover, if it is determined in S160 that the counted time exceeds the abnormality determining time, then the control circuit 20 determines that there is an abnormality such as disconnection occurring in at least one of the charge path Lp or the detection path Ls, and goes into the error mode, and disables charging to the battery 4.

As it is explained above, the battery charger 10 of the present embodiment comprises the detection path Ls besides the charge path Lp. The charge path Lp extends from the terminal T11, which is coupled to the positive electrode of the battery 4, through the terminal K11. The detection path Ls extends from the terminal T11 through the terminal Ksp.

And, the detection path Ls and the charge path Lp are respectively coupled to the voltage-detecting circuit 22 for detecting the battery voltage VB1, and the voltage-detecting circuit 24 for detecting the battery voltage VB2.

And, the control circuit 20 determines that there is an abnormality in at least one of the charge path Lp or the detection path Ls when the absolute value of the difference between the battery voltage VB1 and the battery voltage VB2 is equal to or greater than a specified threshold value Vth, and disables charging to the battery 4.

Thus, according to the battery charger 10 of the present embodiment, charging to the battery 4 is not performed when control of charging to the battery 4 cannot be performed normally due to an abnormality such as disconnection occurring in the charge path Lp or in the detection path Ls; and ultimately, degradation of the battery 4 and the battery charger 10 can be reduced.

In the battery charger 10, the control of charging can be favorably performed since the control circuit 20 performs the control of charging to the battery 4 in accordance with the battery voltage VB1 detected in the voltage-detecting circuit 22 when the control circuit 20 determines that the charge path Lp and the detection path Ls are normal.

The control circuit 20 executes the abnormality determination process shown in FIG. 3 also in the charge-waiting mode, in which charging to the battery 4 is not performed, as well as in the pre-charging mode and charging mode, in which charging to the battery 4 is performed. The threshold value Vth corresponding to each mode is used in the control circuit 20 at this time.

This enables the control circuit 20 to precisely determine whether the charge path Lp and the detection path Ls are normal in the charge-waiting mode, in which the charging current does not flow through the charge path Lp, and in the pre-charging mode and charging mode, in which the charging current flows through the charge path Lp.

While the embodiment of the present disclosure have been described above, it is intended that the present disclosure is not limited to the aforementioned embodiment and may be embodied in various modes within a scope not departing from the spirit of the present disclosure.

For example, in the aforementioned embodiment, the abnormality determination process is executed in the charge-waiting mode in which charging to the battery 4 is not executed, and in the pre-charging mode and charging mode in which charging to the battery 4 is executed. However, the abnormality determination process may be executed only in the charge-waiting mode, which is before initiating charging to the battery 4.

This comes from an assumption that the chance of an abnormality on either one of the charge path Lp or the detection path Ls is small during charging to the battery 4 performed immediately after the determination, made before initiating the charging, that the charge path Lp and the detection path Ls are normal.

And, this can reduce process load on the control circuit 20 during charging to the battery 4 (in other words, in the pre-charging mode or in the charging mode).

Moreover, when executing the abnormality determination process during battery charging, the threshold value for determining an abnormality may be changed not in accordance with the operation mode of the control circuit 20, but in accordance with the value of the charging current. To be more specific, the threshold value may be changed to increase as the value of the charging current increases.

In the aforementioned embodiment, the terminals Ksg and Ksp are respectively coupled to the terminals T10 and T11, which are respectively coupled to the terminal T0 and T1 of the battery pack 2, in order to form the detection path Ls.

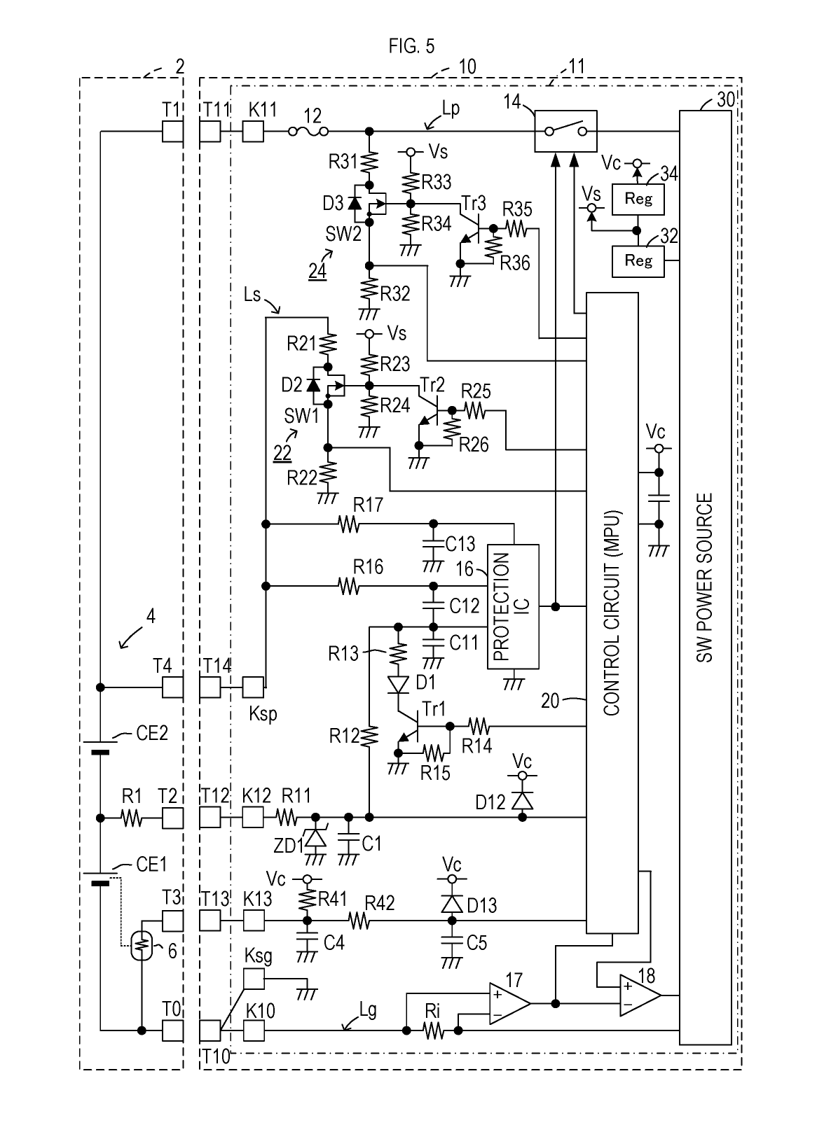

Meanwhile, there is an assumed case where a terminal T4 (a terminal on the positive electrode side) for monitoring the battery voltage is disposed to the battery pack 2 as shown in FIG. 5. In this case, the battery charger 10 may also comprise a detection terminal T14 that corresponds to the terminal T4, and the terminal Ksp may be coupled to this detection terminal T14. This enables more accurate detection of the battery voltage.

There is another assumed case where a terminal coupled to the negative electrode of the battery 4 is disposed to the battery pack 2 as a terminal for monitoring the battery voltage. In this case, the battery charger 10 may also comprise a detection terminal that corresponds to this terminal for monitoring, and the terminal Ksg may be coupled to this detection terminal

In addition, two or more functions of one element in the aforementioned embodiment may be achieved by two or more elements, or, one function of one element in the aforementioned embodiment may be achieved by two or more elements. Likewise, two or more functions of two or more elements in the aforementioned embodiment may be achieved by one element, or, one function achieved by two or more elements in the aforementioned embodiment may be achieved by one element. A part of the configuration of the aforementioned embodiment may be omitted; and, at least a part of the configuration of the aforementioned embodiment may be added to or replaced with other part of the configuration of the aforementioned embodiment. It should be noted that any and all modes that are encompassed in the technical ideas defined only by the languages in the scope of the claims are embodiments of the present disclosure.

What is claimed is:

1. A battery charger comprising:
a positive-electrode terminal and a negative-electrode terminal that are configured to be respectively coupled to a positive electrode and a negative electrode of a battery,
a charging unit that is configured to charge the battery via a charge path that is coupled to the positive-electrode terminal and the negative-electrode terminal,
a first voltage detector that is configured to detect a voltage of the battery via a detection path, which is a different path from the charge path,
a second voltage detector that is configured to detect a voltage of the battery via the charge path, and
a determination unit that is configured to determine that there is an abnormality in at least one of the charge path or the detection path when an absolute value of a difference between the voltage detected by the first voltage detector and the voltage detected by the second voltage detector is equal to or greater than a threshold value.

2. The battery charger according to claim 1, wherein the determination unit is further configured to disable charging to the battery by the charging unit when the determination unit determines that there is the abnormality in at least one of the charge path or the detection path.

3. The battery charger according to claim 1, wherein the determination unit is further configured to set the threshold value to a first threshold value before charging to the battery by the charging unit is initiated, and determine whether there is the abnormality based on the absolute value and the first threshold value.

4. The battery charger according to claim 3, wherein the determination unit is further configured to set the threshold value to a second threshold value that is greater than the first threshold value when charging to the battery by the charging unit is initiated, and determine whether there is the abnormality based on the second threshold value.

5. The battery charger according to claim 4, wherein the determination unit is further configured to increase the second threshold value as a charging current that flows through the charge path increases.

6. The battery charger according to claim 1,
wherein the battery charger is configured to selectively go into one charging mode among two or more charging modes and operate in the one charging mode, and,
wherein the determination unit is further configured to set the threshold value to one threshold value that is appropriate for the one charging mode and determine whether there is the abnormality based on the one threshold value.

7. The battery charger according to claim 1, wherein the detection path is coupled to at least one of the positive-electrode terminal or the negative-electrode terminal.

8. The battery charger according to claim 1, further comprising a detection terminal that is configured to be coupled to at least one of the positive electrode or the negative electrode of the battery, wherein the detection path is coupled to the detection terminal.

9. The battery charger according to claim 1, further comprising a control unit that is configured to control charging to the battery by the charging unit.

10. The battery charger according to claim 1, wherein the battery is configured to be used for worksite power equipment.

11. The battery charger according to claim 1, wherein the battery is housed in a battery pack.

12. A method of detecting an abnormality of a battery charger for charging a battery, the battery charger comprising a charge path and a detection path, which is a different path from the charge path,
the method comprising:
detecting a voltage of the battery via the detection path;
detecting a voltage of the battery via the charge path; and
determining that there is the abnormality in at least one of the charge path or the detection path when an absolute value of a difference between the voltage detected via the detection path and the voltage detected via the charge path is equal to or greater than a threshold value.

13. A method of detecting an abnormality of a battery charger for charging a battery, the method comprising:
providing a charge path to the battery in the battery charger;
providing a detection path that detects a voltage of the battery in addition to the charge path;
detecting a voltage of the battery via the detection path;
detecting a voltage of the battery via the charge path; and
determining that there is the abnormality in at least one of the charge path or the detection path when an absolute value of a difference between the voltage detected via the detection path and the voltage detected via the charge path is equal to or greater than a threshold value.
